(19) United States
(12) Patent Application Publication
(10) Pub. No.: US 2003/0035365 A1
(43) Pub. Date: Feb. 20, 2003

(54) Reducing noise communications lines

(76) Inventors: Robert T. Jurdi, Corona, CA (US); Janusz M. Kucharski, Torrance, CA (US)

Correspondence Address: LEFFERT JAY & POLGLAZE, P.A., P.O. BOX 581009, MINNEAPOLIS, MN, 55458-1009, US

(21) Appl. No.: 09/933,889

(22) Filed: Aug. 20, 2001

(51) Int. Cl. H04J 1/12

(52) U.S. Cl. 370/201; 370/395.1

(57) ABSTRACT

A channel card for communicating asymmetric digital subscriber line (ADSL) traffic over a communication line is provided. The channel card includes an asynchronous transfer mode (ATM) section that provides an interface to a cell bus of a chassis and provides ATM processing of cells. The channel card also includes a transceiver section that is coupled to the ATM section. The transceiver section includes at least one subscriber port. The transceiver section provides for modulation and demodulation of data for the at least one subscriber port. The transceiver section includes a common mode choke for reducing noise on the communication line.

### TECHNICAL FIELD

The present invention relates generally to the field of telecommunications, and, in particular to reducing noise on communications lines.

### BACKGROUND

Telecommunications networks carry signals between equipment in diverse locations. For example, the telephone network was originally designed to carry primarily voice data using a narrow bandwidth transmission scheme. In recent years, the network has been used to carry data, e.g., computer data, in addition to the traditional voice traffic.

Various technologies have been developed to carry data over the telephone network. For example, a variety of modem standards have been promulgated providing for the delivery of data over the public switched telephone network at a variety of data rates. Further, higher speed data transmission over conventional twisted pair telephone wires is provided using a technology referred to as “digital subscriber line” or DSL service.

Digital Subscriber Line (DSL) is a generic name for a family of evolving digital services to be provided by local telephone companies to their local subscribers. DSL includes but is not limited to Single Pair Symmetrical Services (SDSL), Asymmetric Digital Subscriber Line (ADSL), High Bit Rate Digital subscriber line (HDSL) and Very-high-data-rate Digital Subscriber Line (VDSL). These services use various modulation schemes and other techniques to allow the data to be transmitted over the existing copper lines at higher speeds. In addition to data, some of these DSL technologies allow multiple phone lines to share one physical line thus increasing the capacity of the system without the need to install additional copper connections between the customer and the network.

Unfortunately, conventional equipment for providing ADSL service is susceptible to common mode (longitudinal) noise. In many countries, the telephone network does not have a consistent ground reference throughout the network. This introduces substantial levels of ground noise on bundles of twisted pair communication lines in the telephone system. An additional source of common mode noise is cross talk between the twisted pairs in a bundle. Cross talk is caused by capacitive coupling between the wires through proximity in the same bundle.

Common mode noise can substantially reduce the percentage of twisted pairs in a bundle that can support ADSL service. For example, in China, it has been reported that in some locations as little as 10 percent of the twisted pairs in a buddle can be used to support ADSL service at a given time.

For the reasons stated above, and for other reasons stated below which will become apparent to those skilled in the art upon reading and understanding the present specification, there is a need in the art for a technique for reducing common mode noise in communication lines to allow the delivery of high bandwidth data services.

### SUMMARY

The above-reference problems with delivery of ADSL service and other problems are addressed by embodiments of the present invention and will be understood by reading and studying the following specification. Specifically, embodiments of the present invention use a common mode choke in a channel card for providing asymmetric digital subscriber line service that reduces common mode noise for the channel card. Advantageously, embodiments of the present invention reduce common mode noise and cross talk sufficiently to allow a substantial increase in the utilization of communication lines in a bundle to provide ADSL service.

In one embodiment, a channel card for communicating asymmetric digital subscriber line (ADSL) traffic over a communication line is provided. The channel card includes an asynchronous transfer mode (ATM) section that provides an interface to a cell bus of a chassis and provides ATM processing of cells. The channel card also includes a transceiver section that is coupled to the ATM section. The transceiver section includes at least one subscriber port. The transceiver section provides for modulation and demodulation of data for the at least one subscriber port. The transceiver section includes a common mode choke for reducing noise on the communication line.

### BRIEF DESCRIPTION OF THE DRAWINGS

FIG. 1 is a block diagram of one embodiment of a channel card with decreased line noise for a communication system according to the teachings of the present invention.

FIG. 2 is a block diagram of an embodiment of a portion of a channel card with decreased line noise for a communication system according to the teachings of the present invention.

FIG. 3 is a block diagram of an embodiment of a digital subscriber line access multiplexer including a channel card with a noise reduction circuit according to the teachings of the present invention.

### DETAILED DESCRIPTION

In the following detailed description, reference is made to the accompanying drawings that form a part hereof, and in which is shown by way of illustration specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense.

Embodiments of the present invention provide improvements in the provision of asymmetric digital subscriber line (ADSL) service by reducing the effects of common mode noise and cross talk among communication lines, e.g., twisted pairs, in a bundle. This results in an increased percentage of communication lines in the bundle that can support ADSL service.

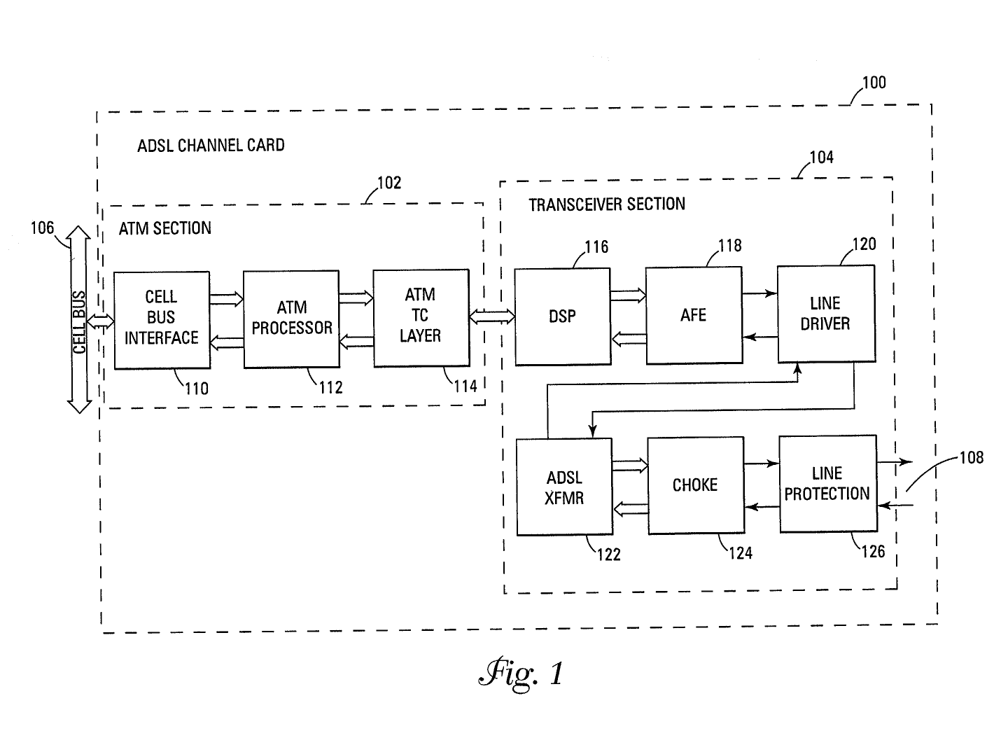

FIG. 1 is a block diagram of one embodiment of an ADSL channel card, indicated generally at 100, with decreased line noise for a communication system according to the teachings of the present invention. Channel card 100 includes two main sections: an asynchronous transfer mode (ATM) section 102 and a transceiver section 104. ATM section 102 and transceiver section 104 are coupled together and transport data bi-directionally between cell bus 106 and data port 108. It is noted that for simplicity in description, a single data port 108 is shown in FIG. 1. However, it is understood that channel card 100 supports any appropriate number of ports 108, e.g., 12 or more ports on a single channel card. ATM section 102 and tranceiver section 104 are discussed in turn below.

ATM section 102 provides ingress and egress of data for channel card 100 in the form of ATM cells. ATM section 102 includes cell bus interface 110. Interface 110 receives cells from and provides cells to cell bus 106. Cell bus 106 comprises, in one embodiment, a cell bus on a backplane of a chassis of, e.g., a digital subscriber line access multiplexer. Interface 110 is also coupled to ATM processor 112 over a Universal Test and Operations PHY Interface for ATM (UTOPIA) bus.

ATM processor 112 provides ATM processing for cells received from and provided to cell bus interface 110. ATM processor 112 provides such functions as cell multiplexing/demultiplexing, cell header generation/extraction, virtual circuit/path management, flow control and any other appropriate ATM layer functions. ATM processor 112 is further coupled to ATM TC layer 114.

ATM TC layer 114 provides the functionality of the tranport convergence layer and is coupled to ATM processor 112 over a UTOPIA bus. Essentially, ATM TC layer 114 provides an interface between ATM processor 112 and transceiver section 104. In the egress direction (toward the subscriber), among other functions, layer 114 removes the data and clock from the ATM cells for transmission by transceiver section 104. In the ingress direction (from the subscriber), layer 114 generates the cells for further processing by ATM processor 112.

Transceiver section 104 includes circuitry that processes data for communication with subscriber equipment. In the egress direction, transceiver section 104 uses the series combination of digital signal processor 116, analog front end 118 and line driver 120 to convert data from digital data received from ATM section 102 to modulated, analog form for transmission out port 108.

Line driver 120 is coupled to ADSL transformer (XFMR) 122 that provides appropriate isolation and line matching for transceiver section 104. Further signals from XFMR 122 are provided through common mode choke 124 and line protection 126 to port 108. Advantageously, common mode choke 124 provides common mode rejection for signals provided to port 108 that reduces common mode noise on the communication lines coupled to port 108. This allows a larger percentage of communication lines in a bundle to be used for providing ADSL service even when the communication lines are part of a network with an inconsistent ground reference through out the network. Line protection circuit 126 provides protection from high voltage, e.g., lightning.

In the ingress direction, the blocks of transceiver section 104 provide the complementary functions necessary to demodulate data received at port 108 to ATM section 102 for processing.

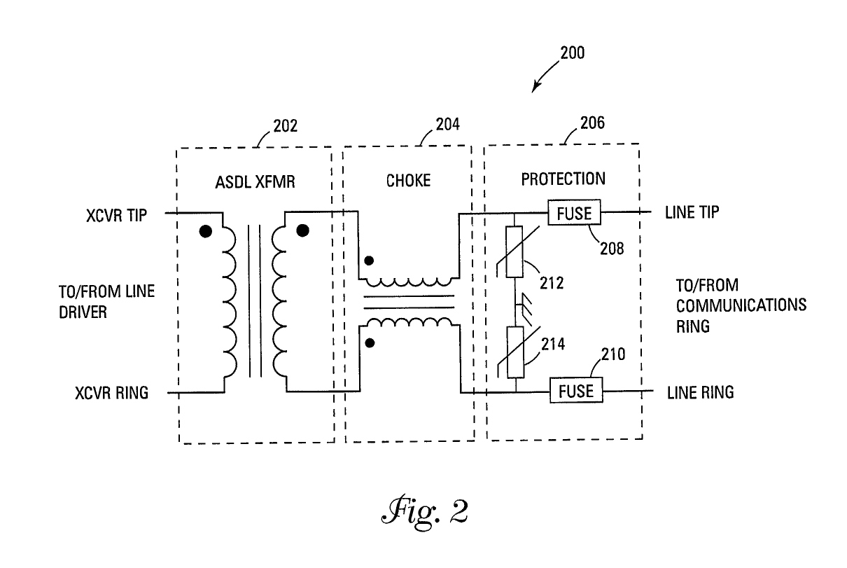

FIG. 2 is a block diagram of an embodiment of a portion a circuit of a channel card, indicated generally at 200, with decreased line noise for a communication system according to the teachings of the present invention. Circuit 200 includes three main components: ADSL transformer 202, common mode choke 204 and protection circuit 206. Each of these components is discussed in turn below.

ADSL transformer 202 provides line matching and isolation for the channel card. ADSL transformer 202 is coupled to a line driver circuit such as line driver 120 of FIG. 1. ADSL transfortmer 202 includes a first input coupled to a XCVR TIP and a second input coupled to a XVCR RING connection of the line driver circuit.

Common mode choke 204 is an iductive choke that provides common mode rejection of noise on a communication line coupled to circuit 200 at LINE TIP and LINE RING. Common mode choke 204 comprises a transformer with one winding coupled in series with the XCVR TIP and the LINE TIP connections and the other winding coupled in series with the XCVR RING and LINE RING connections. Advantageously, the use of common mode choke 204 allows increased penetration of ADSL service in bundles of communication lines even when the communication system has an inconsistent ground reference.

Protection circuit 206 provides protection to the channel card from potential damage from electrical surges due to, for example, lightning or the like. Protection circuit 206 includes fuses 208 and 210 and trasient voltage suppressors (TVSs) 212 and 214. Fuses 208 and 210 are coupled in series with LINE TIP and LINE RING, respectively. TVSs 212 and 214 are coupled in series between fuses 208 and 210.

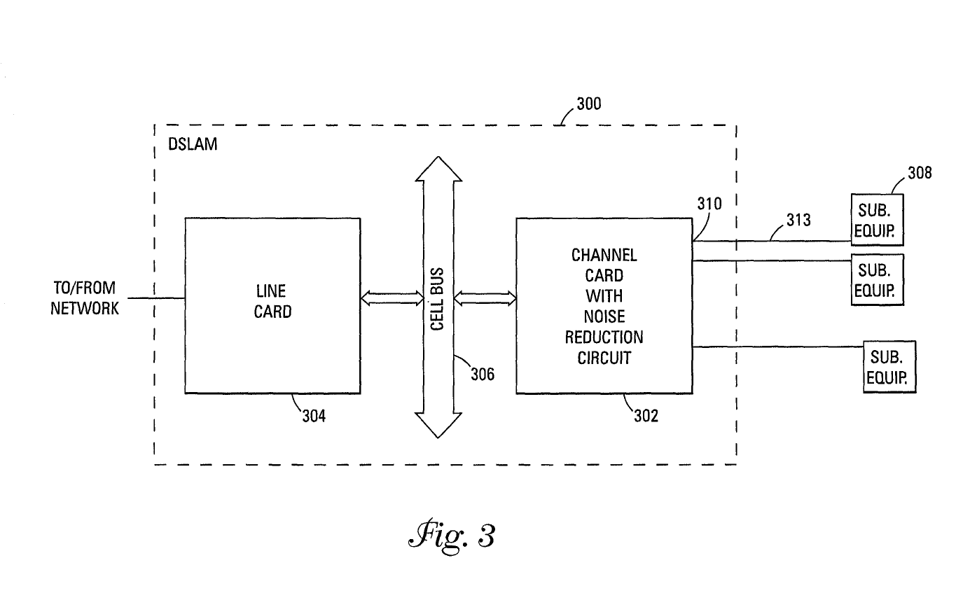

FIG. 3 is a block diagram of an embodiment of a digital subscriber line access multiplexer (DSLAM), indicated generally at 300, including a channel card with a noise reduction circuit 302 according to the teachings of the present invention. DSLAM 300 includes a chassis with a backplane. The backplane of the chassis includes cell bus 306 that provides communication of ATM cells between various cards in the chassis On the subscriber side, DSLAM 300 includes a plurality of channel cards represented by channel card 302. It is understood that although only a single channel card is shown in FIG. 3, DSLAM 300 supports a number of channel cards, each with a plurality of ports for providing service to subscribers 308.

DSLAM 300 also includes slots for receiving a plurality of line cards represented by line card 304. Again, it is understood that only a single line card is shown in FIG. 3. However, any appropriate number of line cards can be selected to populate the slots of a particular DSLAM. These line cards provide an interface to one or more networks. For example, line card 304 comprises one of an OC-3 line card for a SONET ring, a DS3 line card, or other appropriate line card.

Advantageously, channel card 302 includes a noise reduction circuit to allow ADSL service to be provided over an increased percentage of communication lines in a bundle of communication lines. For example, in one embodiment, channel card 302 includes circuitry as described above with respect to FIG. 1 or 2 to provide the noise reduction function.

What is claimed is:

1. A channel card for communicating asymmetric digital subscriber line (ADSL) traffic over a communication line, the channel card including:
an asynchronous transfer mode (ATM) section providing an interface to a cell bus of a chassis and providing ATM processing of cells; and
a transceiver section, coupled to the ATM section, the transceiver section including at least one subscriber port, the transceiver section providing for modulation and demodulation of data for the at least one subscriber port, the transceiver section including a common mode choke for reducing noise on the communication line.

2. The channel card of claim 1, wherein the ATM section includes:
a cell bus interface that is adapted to be coupled to a cell bus;
an ATM processor, coupled to the cell bus, for processing cells; and
an ATM transport convergence layer, coupled to the ATM processor, that provides an interface between the transceiver section and the ATM processor.

3. The channel card of claim 1, wherein the transceiver section includes:
a transformer that provides line matching for the transceiver section;
a protection circuit that provides surge protection for the transceiver section; and
wherein the transformer is coupled in series with the common mode choke and the protection circuit.

4. The channel card of claim 3, wherein the common mode choke comprises a transformer with a first winding in series with a tip connection of the transceiver section and a second winding in series with a ring connection of the transceiver section.

5. The channel card of claim 3, wherein the common mode choke comprises an inductive choke element.

6. A method for reducing common mode noise on a communication line carrying asynchronous subscriber line (ADSL) signals, the method comprising:
receiving ATM cells having data for transmission over the communication line;
processing the cells to remove the data;
preparing the data for transmission as ADSL signals over the communication line; and
passing the ADSL signals through a common mode choke to reduce noise in the ADSL signals prior to transmission.
